(19) United States
(12) Patent Application Publication
(10) Pub. No.: US 2013/0199650 A1
(43) Pub. Date: Aug. 8, 2013

(54) Flow Regulating Applied Magnetic Envelope

(71) Applicant: Douglas C. Cabot, Fort Lauderdale, FL (US)

(72) Inventor: Douglas C. Cabot, Fort Lauderdale, FL (US)

(73) Assignee: THE GREENWARD COMPANY L.L.C., Fort Lauderdale, FL (US)

(21) Appl. No.: 13/806,741

(22) PCT Filed: Jun. 22, 2011
(86) PCT No.: PCT/US11/41529

§ 371 Date: Mar. 4, 2013

Related U.S. Application Data
(60) Provisional application No. 61/357,960, filed on Jun. 23, 2010.

(51) Int. Cl. F16L 55/10

(52) U.S. Cl. CPC F16L 55/10
USPC 138/89

(57) ABSTRACT

A flow control method controls flow in a flow system. In one embodiment, a flow control method for a flow system includes creating a flow regulating applied magnetic envelope at a targeted point in the flow system. The method further includes introducing bridging and obstructing materials to the flow system. In addition, the method includes capturing the bridging and obstructing materials with the flow regulating applied magnetic envelope to create a framework at the targeted point.

### BACKGROUND OF THE INVENTION

1. Field of the Invention

This invention relates to the field of controlling fluid flow and more specifically to the field of reducing fluid flow through a flow system such as a pipe or blowout preventer.

2. Background of the Invention

There is an increasing need for obstructing flow in pipes. For instance, underwater blowouts while drilling for oil wells have provided a particular need for improved methods of stopping oil flow out of the well after a blowout. Conventional means include use of blowout preventers. Drawbacks to blowout preventers include instances in which the blowout preventers fail.

Consequently, there is a need for improved methods of obstructing or stopping flow in flow systems such as pipes without damaging the structure.

### BRIEF SUMMARY OF SOME OF THE PREFERRED EMBODIMENTS

These and other needs in the art are addressed in one embodiment by a flow control method for a flow system that includes creating a flow regulating applied magnetic envelope at a targeted point in the flow system. The method further includes introducing bridging and obstructing materials to the flow system. In addition, the method includes capturing the bridging and obstructing materials with the flow regulating applied magnetic envelope to create a framework at the targeted point.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates various embodiments of bridging and obstructing materials;

FIG. 2 illustrates an embodiment of a flow control method having a series of flow regulating applied magnetic envelopes;

FIG. 3 illustrates an embodiment of a flow control method having reinforcements and pre-attached delivery lines;

FIG. 4 illustrates an embodiment of a flow control method having a flow regulating applied magnetic envelope and cartridges; and

FIG. 5 illustrates an embodiment of a flow control method having reloadable cartridges.

### DETAILED DESCRIPTION OF THE PREFERRED EMBODIMENTS

In an embodiment, a flow control method includes creating a flow regulating applied magnetic envelope, which includes constructing a magnetic field at targeted points in a flow system. In embodiments, the flow control method also includes introducing magnetic bridging and obstructing materials into the flow system. The flow control method obstructs or substantially stops the flow of fluid through the flow system. Without limitation, the magnetic bridging and obstructing materials create at least one obstruction (i.e., framework) in the flow system for the purposeful regulation of the flow of materials and/or fluids, the reduction of the flow of materials and/or fluids, and/or the elimination of the flow of materials and/or fluids in the flow system. The flow system may be any type of system through which fluid flows. In an embodiment, the flow system is a pipe, riser, blowout preventer, or the like. In some embodiments, the flow system is disposed in a nuclear cooling plant. The fluid may be any fluid. In an embodiment, the fluid includes oil. In other embodiments, the fluid is a gas flowing in a flow system.

In embodiments, the flow regulating applied magnetic envelope is employed in response to a flow through a flow system. In other embodiments, the flow regulating applied magnetic envelope is disposed on the flow system prior to the flow. In some embodiments, the flow regulating applied magnetic envelope is disposed in preparation (i.e., on standby) for deployment to a flow system when desired. For instance, in an embodiment, the flow regulating applied magnetic envelope is an integrated part of a blowout preventer at manufacture. In other embodiments, the flow regulating applied magnetic envelope is a modification to an existing blow out preventer. For instance, in embodiments, a blank may be provided where a ram may typically be disposed on a blowout preventer to allow the magnets to be disposed thereon.

In embodiments, the flow regulating applied magnetic envelope provides flow regulation to a flow system where the intended flow control point may not be easily or readily reached or in instances in which access to the exterior of a pipe or system may be obstructed. Without limitations, examples of such instances of use of the flow regulating applied magnetic envelope include sub-surface applications, well casing rupture, debris obstruction, physical hazards (i.e., fire, electrical, nuclear, chemical, and the like). In an embodiment, the flow regulating applied magnetic envelope includes targeted choke points of the desired structure that are locally magnetized with the focus envelope of the magnetic field, which include the internal portion of the targeted structure. Without limitation, the flow regulating applied magnetic envelope facilitates installment of magnets or cross-pieces of magnets (i.e., a quick hook up of magnets/magnet cross pieces). For instance, in embodiments, a robot is disposed to install the magnets.

Any type and configuration of magnet suitable for use with the flow regulating applied magnetic envelope are suitable. In embodiments, any suitable magnet for creating a magnetic field may be used. Without limitation, examples of suitable magnets include permanent magnets and electromagnets. The permanent magnets may have any suitable configuration. In some embodiments, the magnets are adjustable and configurable for irregular surfaces. For instance, embodiments include the permanent magnets having square or curved configurations. In some embodiments, the permanent magnets may have any desirable irregular shape. The magnets may be applied by any suitable method. In embodiments, the magnets may be physically placed on the desired structure or by the placement and/or wrapping of the wires of an electromagnet around the desired structure. The magnets may be attached to a structure with any type of surface such as a flat, curved, or irregular surface. The magnets may also be composed of any elemental composition and blend suitable for regulation of flows and electron flow management in and around the flow regulating applied magnetic envelope. The permanent magnets may be composed of any suitable material. In embodiments, the permanent magnets are composed of neodymium, boron, graphene, other suitable materials, or any combinations thereof. The permanent magnets may be composed of any suitable amount of boron. In embodiments, the permanent magnets have between about 50 wt. % and about 60 wt. % boron. Without limitation, boron absorbs neutrons and has a suitable curie point. In addition, without limitation, stretching of graphene creates a magnetic field. For instance, permanent magnets that include graphene may be wrapped around the outside of a pipe to provide the magnetic field. In embodiments in which the flow system includes a superstructure, embodiments of the flow regulating applied magnetic envelope include locally magnetizing targeted choke points of the superstructure with the focus envelope of the magnetic field including the internal portion of the targeted structure (e.g., risers, blowout preventers, pipes, and the like). The magnets may be attached at any suitable attachment points on the superstructure (i.e., blowout preventer) of the flow system. Examples of suitable attachment points include flip or fold out attachment points (i.e., the magnets are flipped or folded out in the blowout preventer), the attachment points are pre-wired, and/or the attachment points are pre-drilled points in which the magnets are inserted or disposed. In some embodiments, the magnet is a manually deployed cross-piece that is swung down into the superstructure (i.e., pipe).

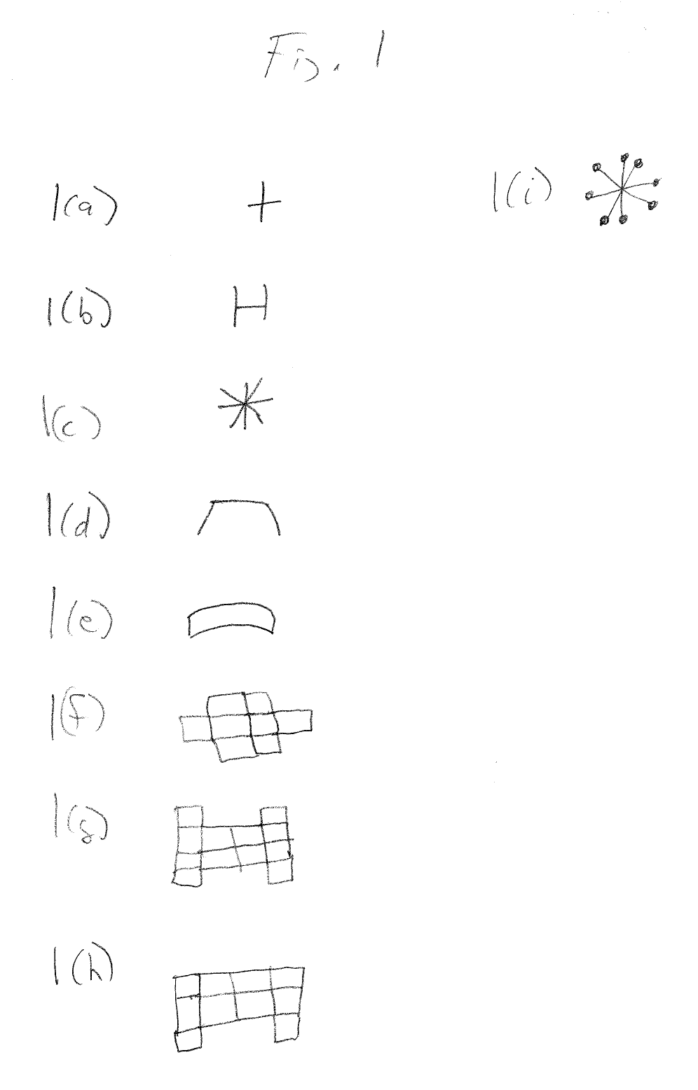

In embodiments, the flow control method includes bridging and obstructing materials. The bridging and obstructing materials may be composed of any desirable materials. In an embodiment, the bridging and obstructing materials include any materials composed of various chemical and elemental combinations that have the electrical charge and atomic structures to achieve the intended flow regulation and electron management in and around the flow regulating applied magnetic envelope environment. In embodiments, the bridging and obstructing materials include materials that are attracted to magnets. In an embodiment, the bridging and obstructing materials include ferromagnetic materials. In some embodiments, the magnets include rare earth materials or neodymium materials. In an embodiment, the bridging and obstructing materials include boron, copper, or any combinations thereof. Without limitation, the copper may be accelerated and/or decelerated from the outside or from within the flow system. Further, without limitation, the copper and/or boron absorb radioactivity (i.e., when disposed in a nuclear cooling plant). The bridging and obstructing materials may have any suitable strengths of magnetism. In addition, the bridging and obstructing materials may include any suitable configuration. Examples of suitable configurations include two crossed portions (FIG. 1(a)), a plurality of crossed portions (FIG. 1(c)), curved portions (i.e., curved for hydrodynamic lift) (FIG. 1(e)), in the configuration of an H (FIG. 1(b)), two angled sides with a side connecting the ends of the two angled sides closest to each other (FIG. 1(d)), or any combinations thereof. In some embodiments, the bridging and obstructing materials include stacks of about equal sized cubes. For instance, in embodiments, the stacks include three blocks high by four blocks wide (such as the embodiment of FIG. 1(f), four blocks high by four blocks wide (such as the embodiment of FIG. 1(g)), three blocks high by four blocks wide (such as the embodiment of FIG. 1(h)), or any combinations thereof. In embodiments as shown in FIG. 1(a), the two crossed portions may be perpendicular. In an embodiment as shown in FIG. 1(i), the plurality of crossed sections may have a solid circular end on the end opposite that of the ends that cross each other. The bridging and obstructing materials may also have any suitable dimensions. In embodiments, for example, the bridging and obstructing materials have the dimensions of 1.92 inch×1.44 inch or 1.92 inch×1.92 inch. It is to be understood that the bridging and obstructing materials may be tailored to the flow system (e.g., pipe) size, characteristics, and/or objectives thereof. In embodiments, multiple types of bridging and obstructing materials (i.e., different configurations, compositions, and strengths) are introduced to maximize intended control points. In an embodiment, the bridging and obstructing materials are tailored to the flow system and are designed to minimize damage to the superstructures (i.e., pipe and systems) and reduce the possibility of a spark or excess heat. Without limitation, the hydrodynamic flow, lift, buoyancy, and pairing characteristic of the materials are considered in selection. Further, without limitation, selection of the materials may be intended to encourage or discourage hydrate formations within the flow system, and also has consideration for minimizing brittle characteristics of the materials.

In some embodiments, the bridging and obstructing materials are functionalized. The bridging and obstructing materials may be functionalized for any suitable purpose. Without limitation, functionalized bridging and obstructing materials include functionalization for thermal activated/adjusted bridging and obstructing materials, crush activated/accumulating bridging and obstructing materials, shear thickening bridging and obstructing materials, magnetically activated bridging and obstructing materials, Kelvin-Helmholtz instability facilitating bridging and obstructing materials, capsule deployed bridging and obstructing materials, timer activated bridging and obstructing materials, remote activated bridging and obstructing materials, ROV activated bridging and obstructing materials, sensor feedback activated bridging and obstructing materials, foam, glue, and/or elemental bridging and obstructing materials. Capsule deployed bridging and obstructing materials include one or more bridging and obstructing materials encapsulated in a material. The material may be any material suitable for encapsulating the bridging and obstructing materials. The encapsulating material may be activated by any suitable means (i.e., electrical signal, dissolution, and the like) to release the encapsulated bridging and obstructing materials. In some embodiments of the flow control method, during the deployment of the bridging and obstructing materials to the flow regulating applied magnetic envelope, delivery capsules and/or modules may systematically fracture. In addition to any payload of bridging and obstructing materials delivered, such capsules and/or modules may deliver structural pieces of themselves to become a port of the flow regulating applied magnetic envelope. In embodiments, the bridging and obstructing materials are released when in a suitable position within the environment of the flow regulating applied magnetic envelope. In some embodiments, the bridging and obstructing materials include functionalized magnetorheological and electro rheological fluids as well as colloidal solutions, Ferro fluids, and paramagnetic fluids.

In other embodiments, the flow control method includes injecting the bridging and obstructing materials into the flow system and delivery thereof to the flow regulating applied magnetic envelope. Any suitable injection method may be used. In an embodiment, the injection methods include manifold injection, hose injection, drill pipe injection, and any specialized implements configurable for injection. In some embodiments, delivery of the bridging and obstructing materials to the flow regulating applied magnetic envelope is accomplished by disposing the bridging and obstructing materials in cartridges. In embodiments, the flow control method includes delivering the cartridges to the desired position at which the cartridges are activated to release the bridging and obstructing materials. The cartridges may be activated by any suitable means such as by an electrical signal. In an embodiment, one or more cartridges are disposed on a drill pipe and delivered to the desired position. An electrical signal is then sent through the drill pipe to active the cartridges and release the bridging and obstructing materials. The magnets then capture the bridging and obstructing materials to provide a framework. In embodiments, the cartridges have different types of bridging and obstructing materials. For instance, the first cartridge has larger bridging and obstructing materials with each successive cartridge having smaller bridging and obstructing materials.

In embodiments of the flow control method, various bridging and obstructing materials (e.g., of a ferrous nature) are inserted into the flow system. The bridging and obstructing materials may then be attracted to and captured by the magnetic field created by the magnets, and therefore become magnetically attracted, attached, and/or held to the inside of the structures of the flow system (e.g., superstructures within the scope of the targeted magnetic field envelope) to provide framework. In embodiments, the bridging and obstructing materials are designed to flow in the flow system and minimize the possibility of damage to the flow system (e.g., pipe). Further, embodiments include the bridging and obstructing materials composed of a composition that reduces the possibility of spark or excess heat. In other embodiments, the hydrodynamic flow, lift, buoyancy, and pairing characteristics of the materials are considered in selection. In further embodiments, the intended encouragement or discouragement of hydrate formations within the system and considerations for minimizing brittle characteristics of the materials are also factored into the materials selection.

In embodiments, the flow control method includes follow up bridging and obstructing materials. The follow up bridging and obstructing materials may be added subsequent to the initial insertion of the bridging and obstructing materials. Such follow up bridging and obstructing materials may be of any suitable composition. In embodiments, the follow up bridging and obstructing materials are ferrous materials, non ferrous materials, or any combinations thereof. In some embodiments, the follow up bridging and obstructing materials may also include additional bridging and obstructing materials. The additional bridging and obstructing materials may be more specifically designed to fill in and fully obstruct, choke, and/or clog any remaining small openings that may remain at the targeted choke point (i.e., in the framework). Follow up bridging and obstructing materials may include custom capsule/functionalized elements (i.e., copper and/or boron), materials may be of one uniform construction, or combined into one piece of varying composition, small particles suspended in solution, shear thickening fluids, ground and shredded materials of varying sizes, steel wool, wire, foam capsule, rubber material/adhesive, materials exhibiting Kelvin-Helmholtz instability, materials packed together that separate when disposed in a desired position, or any combinations thereof.

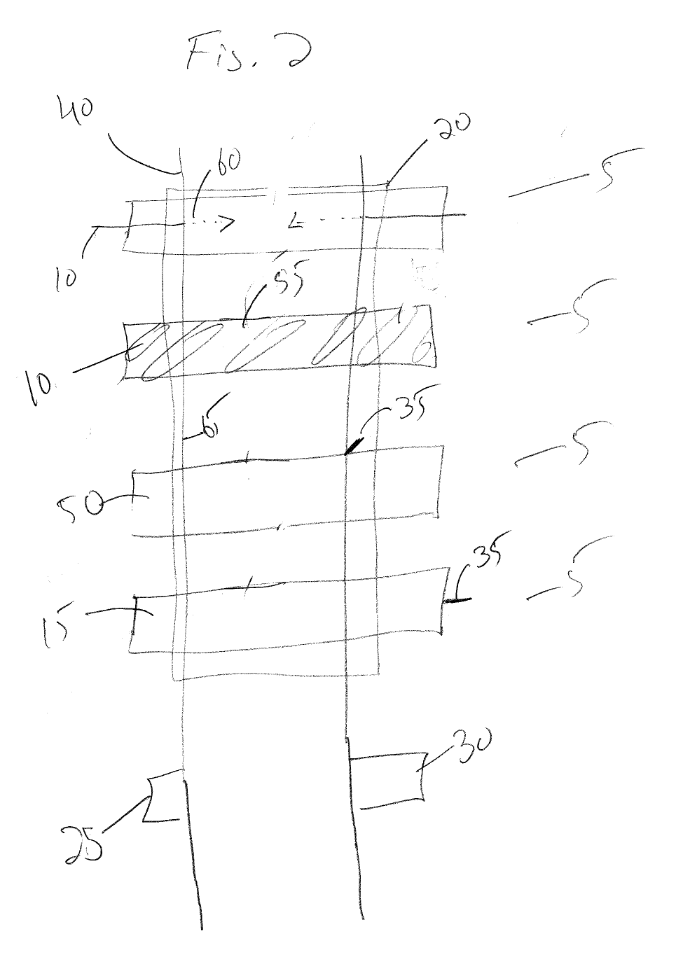

In embodiments, the flow control method includes creating the flow regulating applied magnetic envelope having a desired choke point at which the flow is desired to be obstructed or stopped. In other embodiments, the flow control method includes multiple choke points in the flow regulating applied magnetic envelope. In some embodiments, the flow control method includes multiple in-line targeted magnetic choke points that may be upstream or downstream of each other. FIG. 2 illustrates an embodiment of the flow control method having multiple flow regulating applied magnetic envelopes 5 with targeted choke and obstruction points. As shown, the flow control method includes inserting a series of integrated attachment points in a blowout preventer 20 at which magnetic fields attract and capture bridging and obstructing materials. In the embodiment as shown, the bridging and obstructing materials are inserted into the flow system 40 at injection point 30, which is upstream of the blowout preventer 20. The flow downstream to the blowout preventer 20 to a first magnetic field 15 at which the magnetic field is created by a magnet disposed at an attachment point 35 on the side of the blowout preventer 20 (e.g., a shaping magnetic field). Remaining bridging and obstructing materials continue to flow downstream to the second magnetic field 50 at which the magnetic field is created by a magnet disposed at an attachment point 35 at the intersection of the blowout preventer and pipe 65 (e.g., a catch and release magnetic field). In embodiments, remaining bridging and obstructing materials flow downstream to the third magnetic field 55 that is created by electromagnets 10 wrapped around the outside of the blowout preventer 20 (e.g., a capture and hold magnetic field). The remainder of the bridging and obstructing materials flow downstream to the fourth magnetic field 60 that is created by the blowout preventer with rams that have been made electromagnetic 10 (e.g., a reverse hold magnetic field). It is to be understood that the flow control method is not limited to the flow regulating applied magnetic envelopes 5 shown, but instead may have any desirable number of integrated attachment points created by any desired type of created attachment points and magnetic fields. In embodiments, the flow control method has a backup secondary injection point 25.

In embodiments, the flow control method includes a control panel for the flow regulating applied magnetic envelope for electromagnets, which controls reactivation of the magnets, how long the magnets are activated, and the power at which the magnets are activated. In embodiments, the control panel includes control categories for shapes of the magnets, catch/release speed, capture/hold power, reverse hold power, and the like, or any combinations thereof. In an embodiment, each category has a hi/low power control (e.g., analog power). In an embodiment, the control panel also includes computer control sequences (i.e., pulses and timed sequences).

In some embodiments, cross materials may also be added to the flow system (e.g., pipe) by the flow control method. The cross materials may include any suitable design to assist with the capture and retention of the bridging and obstructing materials. In some embodiments, the cross materials assist with the bridging and capture at about the mid channel of the flow. In embodiments, the cross materials include an insert, a cross rod, a cross lattice-work or scaffolding that may be added to the interior (i.e., midchannel) of the targeted flow system (e.g., pipe).

In embodiments, the flow control method includes a bridging and obstructing material insertion procedure for high pressure systems. In an embodiment, a line is attached to an anchor point. The line may be of any suitable material and configuration such as a chain, cable, or the like. In embodiments, the line comprises ferrous materials. To the line, measured lengths of bridging and obstructing materials are metered out. In an embodiment, the line is first inserted through a fluid lock valve and secured to an anchor point (i.e., attachment point) within the flow system. When introduced to the fluid flow (e.g., oil flow), the bridging and obstructing material on the line is delivered to the desired region for optimal capture probability to form basic framework upon which more bridging and obstructing materials may be inserted, attracted to, and captured by the magnetic field. In embodiments, the line may also be released to provide further framework (i.e., when captured by the magnetic field). In other embodiments, the bridging and obstructing materials may be inserted by pipe and/or on a pipeline pig instead of or in addition to the line.

In an embodiment, the flow control method is used in the instance of an overpressure of the flow system. For instance, in an emergency overpressure event in which the magnets are electromagnets, the magnets may be rapidly demagnetized or turned off, which may allow materials to pass downstream and thereby reduce the possibility of damage to the flow system.

In embodiments, the flow control method includes flow wheels that measure flow and comparative flow for accurate placement of the flow regulating applied magnetic envelope. The flow wheels may be disposed by any suitable method. In an embodiment, the flow wheels are disposed on a line or pipe.

In an embodiment, the flow control method includes placing the flow regulating applied magnetic envelope onto/over or inside a ruptured casing. When activated, the flow regulating applied magnetic envelope spans the breach of the rupture and regulates flow through the casing and prevents flow out of the casing through the breach. In other embodiments, the flow regulating applied magnetic envelope provides reinforcements to the flow system (i.e., pipe) for a reduced bulge or slip.

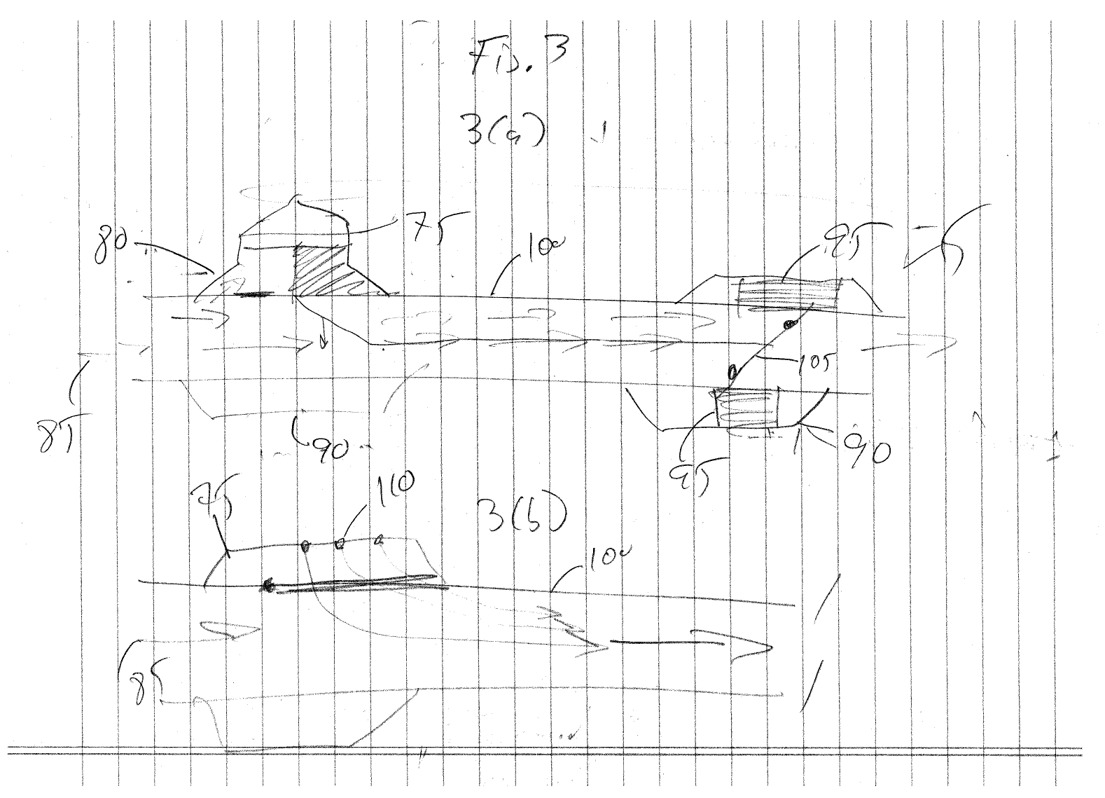

FIGS. 3(a), (b) show reinforcements and delivery of the flow regulating applied magnetic envelope 5. FIG. 3(b) is an embodiment of the flow control method showing the pre-attached delivery lines 110 disposed in the embodiment shown in FIG. 3(a). A delivery manifold 75 is disposed at a proper depth. Reinforcements 90 are added to the pipe 100 on sides at delivery manifold 75 and downstream for placement of the magnet 95. Pre-attached delivery lines 110 are attached to the delivery manifold 75 and provide the bridging and obstructing material and/or the cross-bridging structure 105. Flow diverter 80 diverts flow through the delivery manifold 75. Delivery manifold 75 delivers cross-bridging structure 105 to flow regulating applied magnetic envelope 5 created by magnet 95 by pre-attached delivery lines 110.

In embodiments, the flow control method includes attaching two valves in the delivery manifold. Valve one separates the delivery manifold from the flow system (e.g., pipe), and valve two separates the delivery manifold into two chambers. The delivery manifold then includes a first chamber between valve one and valve two, and a second chamber distal to the pipe and that includes the access panel. In operation, valve one is opened, filled to pressure, and closed. Bridging and obstructing materials are added through the access panel in the second chamber. Valve two is opened to combine the two chambers. Valve one is then opened to feed the bridging and obstructing materials to the flow system.

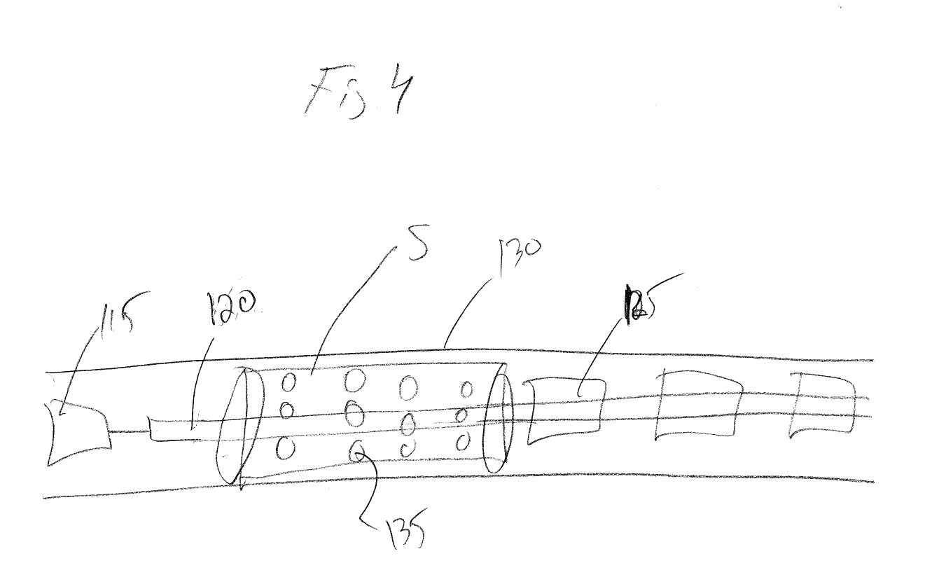

FIG. 4 illustrates another embodiment of the flow control method. As shown, the flow regulating applied magnetic envelope 5 is lowered downstream on a pipe 120 along with cartridges 125. The flow regulating applied magnetic envelope 5 is lowered until disposed in a breach of casing 130. In embodiments, the flow regulating applied magnetic envelope 5 may include feedback sensors of the flow rate through the flow regulating applied magnetic envelope 5 for accurate depth placement of the flow regulating applied magnetic envelope 5. In embodiments, the flow regulating applied magnetic envelope 5 spans the breach for structural support. In embodiments as shown, the flow regulating applied magnetic envelope 5 has orifices 135 through which material may flow until the electromagnets in the flow regulating applied magnetic envelope 5 are magnetized. When the flow regulating applied magnetic envelope 5 is magnetized by power/control 115, the primary delivery of bridging and obstructing materials through the pipe 120 provides framework within the flow regulating applied magnetic envelope 5. Secondary and/or primary delivery of the bridging and obstructing materials may be through the cartridges 125.

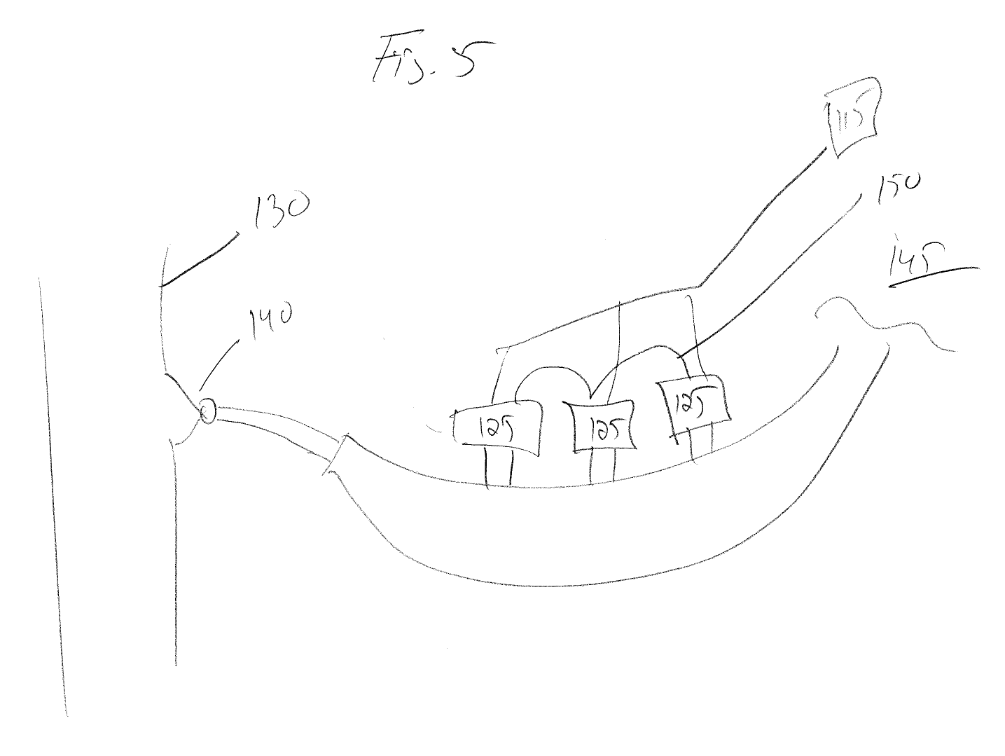

FIG. 5 illustrates an embodiment of the flow control method for introducing functionalized bridging and obstructing materials to the flow system (e.g., casing 130). As shown, reloadable cartridges 125 are disposed in a panel with an injection pump 150 that provides the functionalized bridging and obstructing materials to the reloadable cartridges 125. A main pump 145 provides a one way flow to the casing 130 through the connection 140 (e.g., the connection to the blow out preventer/stack). The panel may include any suitable number of reloadable cartridges 125. A power/control panel 115 controls the panel of reloadable cartridges 125 and release of the functionalized bridging and obstructing materials. The bridging and obstructing materials when released flow through the one way flow and the connection 140 to the flow system in casing 130 and to the flow regulating applied magnetic envelope (not illustrated).

In some embodiments, as part of the flow regulating applied magnetic envelope application on pipe and downhole, a module that spans a breech may functionally distort or crush as part of the flow regulating applied magnetic envelope construction. In an embodiment, as a part of the flow regulating applied magnetic envelope application on pipe and downhole, the flow and/or movement of nonferrous and/or non magnetized material may be maintained and regulated through a pipe within the flow regulating applied magnetic envelope. Before, during, and after any activation/magnetization of the flow regulating applied magnetic envelope, fluid movement may be separately regulated and controlled through a pipe and may be regulated with mechanical and/or electrical valves and flow control systems.

In alternative embodiments, upon activation/magnetization of the flow regulating applied magnetic envelope, and/or as pressure builds in a system as a breech or leak is closed/stopped, and/or as the targeted flow point is controlled; pressures building up within the system may be optionally relieved, vented, or regulated through a pipe.

In embodiments, the flow control method includes a capture apparatus. The capture apparatus may include any structure suitable for capturing vented materials near the end flow or vent for the recapture and use of any vented bridging and obstruction materials. In embodiments, the capture apparatus is a net. In some embodiments, the capture apparatus is magnetically charged.

What is claimed is:

1. A flow control method for a flow system, comprising:
(A) creating a flow regulating applied magnetic envelope at a targeted point in the flow system;
(B) introducing bridging and obstructing materials to the flow system; and
(C) capturing the bridging and obstructing materials with the flow regulating applied magnetic envelope to create a framework at the targeted point.

2. The flow control method of claim 1, wherein the flow regulating applied magnetic envelope comprises a magnet.

3. The flow control method of claim 2, wherein the magnet comprises a permanent magnet.

4. The flow control method of claim 2, wherein the magnet comprises an electromagnet.

5. The flow control method of claim 4, wherein the flow system comprises a superstructure, and wherein the flow control method further comprises the electromagnet disposed on an exterior of the superstructure.

6. The flow control method of claim 4, wherein the flow system comprises a superstructure, and wherein the flow control method further comprises the electromagnet disposed on an interior of the superstructure.

7. The flow control method of claim 4, wherein the flow system comprises a superstructure, and wherein the flow control method further comprises the electromagnet disposed in a ram of a blowout preventer.

8. The flow control method of claim 1, wherein the bridging and obstructing materials comprise ferromagnetic materials.

9. The flow control method of claim 1, further comprising introducing follow up bridging and obstructing materials to the flow system.

10. The flow control method of claim 9, further comprising capturing the follow up bridging and obstructing materials with the flow regulating applied magnetic envelope.

11. The flow control method of claim 1, further comprising introducing the flow regulating applied magnetic envelope to the flow system.

12. The flow control method of claim 11, wherein the flow regulating applied magnetic envelope is introduced on a pipe.

13. The flow control method of claim 12, further comprising introducing the bridging and obstructing materials to the flow system through the pipe.

14. The flow control method of claim 1, further comprising introducing bridging and obstructing materials to the flow system by a cartridge.

15. The flow control method of claim 14, further comprising controlling release of the bridging and obstructing materials from the cartridge.

16. The flow control method of claim 1, wherein the flow regulating applied magnetic envelope comprises a plurality of orifices.

17. The flow control method of claim 1, further comprising inserting a line into the flow system to introduce the bridging and obstructing materials to the flow system.
